(19) United States
(12) Patent Application Publication
(10) Pub. No.: US 2021/0112099 A1
(43) Pub. Date: Apr. 15, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kenji TAKAO, Kanagawa (JP)

(73) Assignee: FUJI XEROX CO., LTD., Tokyo (JP)

(21) Appl. No.: 16/896,371

(22) Filed: Jun. 9, 2020

(30) Foreign Application Priority Data
Oct. 9, 2019 (JP) 2019-185792

(51) Int. Cl. H04L 29/06

(52) U.S. Cl. CPC H04L 63/20; H04W 12/0027; H04L 63/02

(57) ABSTRACT

An information processing apparatus includes an obtainer, a first sender, a receiver, a second sender, and a decider. The obtainer obtains an information protection policy from a management device. The management device is unable to communicate with a service providing device. The first sender sends the information protection policy to the service providing device. The receiver receives from the service providing device a collation result indicating whether or not the service providing device conforms to the information protection policy. The second sender sends the collation result to the management device. The decider decides that it is possible to use the service providing device if information indicating that the service providing device conforms to the information protection policy is received from the management device.

### CROSS-REFERENCE TO RELATED APPLICATIONS

This application is based on and claims priority under 35 USC 119 from Japanese Patent Application No. 2019-185792 filed Oct. 9, 2019.

### Background

### (i) Technical Field

The present disclosure relates to an information processing apparatus and a non-transitory computer readable medium.

### (ii) Related Art

Japanese Patent No. 6318698 discloses a system for managing the security of multiple client devices connected with each other via a network. The system includes a receiver, a determiner, a notifier, and a register. The receiver receives information for changing the security level of a certain client device. A definition table is provided in which security setting values of the multiple client devices are defined. In accordance with a change in the security setting value of the certain client device based on the received information, the determiner selects a specific client device for which the security setting value will be changed and also determines the security setting value for this specific client device, based on the definition table. The notifier notifies the specific client device of the determined security setting value. The register registers security setting values of the multiple client devices in a setting table. In accordance with a change in the security setting value of the certain client device, the determiner selects a client device whose security setting value defined in the definition table and that registered in the setting table are different, and determines the security setting value of the selected client device.

Japanese Patent No. 5538132 discloses a terminal system including a terminal and a terminal management server. The terminal includes a memory. The terminal management server is connected to the terminal via a network. The terminal includes an authentication requester, an authenticity checker, an authenticity checking result sender, and a confidential information processor. The authentication requester connects to an ID device storing a preset ID and authentication information, obtains the ID and the authentication information from the ID device, and sends the ID and the authentication information to the terminal management server as an authentication request. The authenticity checker checks the state of the memory. The authenticity checking result sender sends the authenticity checking result obtained by the authenticity checker to the terminal management server. The confidential information processor decrypts service use authentication information, which will be used by a user to use a service of a service providing server, with a private key associated with a public key. The service use authentication information has been encrypted with the public key within the ID device. The terminal management server includes a terminal information register, an authenticator, an authenticity verifier, a unique information sender, and a terminal public key manager. The terminal information register registers in advance unique information indicating user environments and used for identifying the user of the terminal. The authenticator conducts authentication by checking the ID and the authentication information included in the authentication request received from the terminal against preset user information. The authenticity verifier determines whether or not the terminal is falsified, based on the authenticity checking result received from the terminal. If the authenticator has successfully conducted authentication and if the authenticity verifier determines that the terminal is not falsified, the unique information sender sends unique information concerning the user to the terminal. The terminal public key manager manages the public key. The terminal includes a service processor. The service processor displays the unique information concerning the user received from the terminal management server to enable the user to check that the terminal is an authorized device. The service processor also sends a service request including the service use authentication information decrypted with the private key and terminal information including the authenticity checking result of the authenticity checker to the service providing server so that the service providing server can conduct verification.

### SUMMARY

When a user uses a service providing device, a management device that manages the organization of the user is required to check whether the service providing device conforms to the information protection policy set by the organization. Nevertheless, in a remote working environment where the management device and the service providing device are unable to communicate with each other, it is difficult for the management device to connect to the service providing device. The management device thus fails to check whether the service providing device conforms to the information protection policy and to determine whether to allow the user to use the service providing device.

Aspects of non-limiting embodiments of the present disclosure relate to providing an information processing apparatus and a non-transitory computer readable medium in which, in an environment where a management device and a service providing device are unable to communicate with each other, when a user uses the service providing device via the information processing apparatus, the information processing apparatus makes it possible for the management device to check whether the service providing device conforms to the information protection policy managed by the management device and to determine whether to allow the user to use the service providing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an obtainer, a first sender, a receiver, a second sender, and a decider. The obtainer obtains an information protection policy from a management device. The management device is unable to communicate with a service providing device. The first sender sends the information protection policy to the service providing device. The receiver receives from the service providing device a collation result indicating whether or not the service providing device conforms to the information protection policy. The second sender sends the collation result to the management device. The decider decides that it is possible to use the service providing device if information indicating that the service providing device conforms to the information protection policy is received from the management device.

### BRIEF DESCRIPTION OF THE DRAWINGS

An exemplary embodiment of the present disclosure will be described in detail based on the following figures, wherein:

FIG. 1 is a schematic diagram illustrating an example of the system configuration utilizing the exemplary embodiment;

FIG. 2 is a block diagram illustrating conceptual modules forming an example of the configuration of an information processing apparatus according to the exemplary embodiment;

FIG. 3 is a block diagram illustrating conceptual modules forming an example of the configuration of a service providing device according to the exemplary embodiment;

FIG. 4 is a block diagram illustrating conceptual modules forming an example of the configuration of an image processing device used as the service providing device;

FIG. 5 illustrates an example of processing executed in the exemplary embodiment;

FIG. 6 is a schematic diagram of specific modules forming an example of the configuration of the exemplary embodiment;

FIG. 7 is a flowchart illustrating an example of processing executed in the exemplary embodiment;

FIG. 8 is a flowchart illustrating an example of processing executed in the exemplary embodiment;

FIG. 9 illustrates an example of processing executed in the exemplary embodiment;

FIG. 10 is a flowchart illustrating an example of processing executed in the exemplary embodiment;

FIG. 11 illustrates an example of the data structure of a security policy table;

FIG. 12 is a flowchart illustrating an example of processing executed in the exemplary embodiment;

FIG. 13 illustrates an example of processing executed in the exemplary embodiment;

FIG. 14 is a schematic diagram of specific modules forming an example of the configuration of the exemplary embodiment;

FIG. 15 illustrates an example of the data structure of an alternative-function table;

FIG. 16 is a flowchart illustrating an example of processing executed in the exemplary embodiment;

FIG. 17 illustrates an example of processing executed in the exemplary embodiment; and

FIG. 18 is a block diagram illustrating an example of the hardware configuration of a computer implementing the exemplary embodiment.

### DETAILED DESCRIPTION

An exemplary embodiment of the disclosure will be described below with reference to the accompanying drawings.

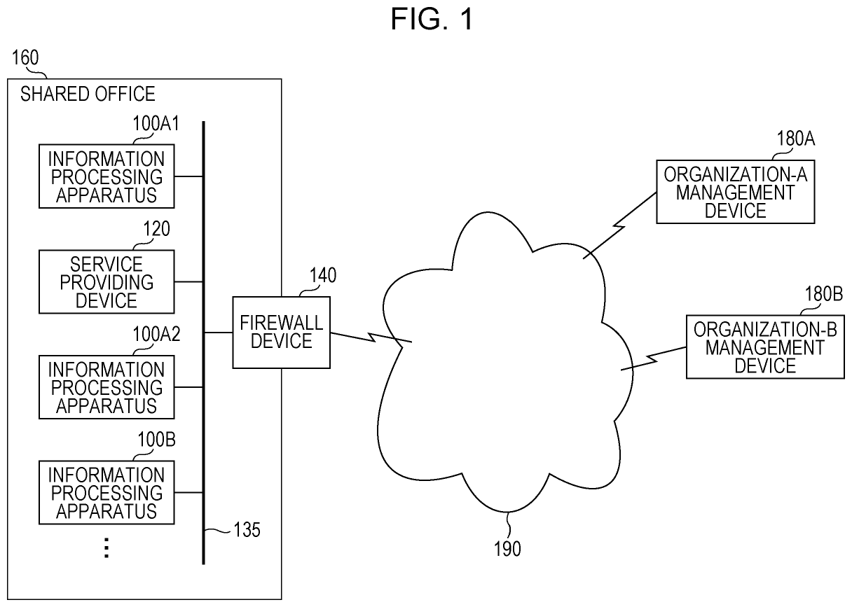

FIG. 1 is a schematic diagram illustrating an example of the system configuration utilizing the exemplary embodiment.

The exemplary embodiment is concerned with a technology for checking the security settings of a service providing device 120 installed in a remote working environment, such as in a shared office or a coworking space. The service providing device 120 will be discussed through illustration of a multifunction device (an image processing device having at least two of the functions of a scanner, a printer, a copying machine, and a fax machine).

Hitherto, typically, the use of a multifunction device is restricted to an in-house network environment. The administrator of a multifunction device installed in a company is also the administrator of the network within this company. The administrator sets security settings of the multifunction device and manages them in accordance with the security policy of the company. In such a situation, the security settings of the multifunction device are less likely to be altered by someone else other than the administrator. Environments where communications are made with the multifunction device are reliable, and information concerning the state of the multifunction device sent from the multifunction device are also reliable without the need to check whether the multifunction device conforms to the security policy of the company. An example of the technology for managing multiple client devices in accordance with the security policy of a certain company in an environment such as the above-described in-house network environment is disclosed in Japanese Patent No. 6318698.

In contrast, in a multifunction device in a remote working environment, the company of the administrator of the multifunction device and that of a user using the multifunction device are usually different. Additionally, the security settings of the multifunction device set by the administrator do not necessarily conform to the security policy of the company of the user. The technology disclosed in Japanese Patent No. 6318698 is based on the assumption that the administrator of the security policy of a certain company and the administrators of client devices managed by this company belong to the same organization and that the system disclosed in this publication is operated based on the same security policy. The technology disclosed in this publication is not sufficient to handle a situation where a multifunction device is disposed in a remote working environment. An organization is a group that is able to set a security policy and is a company or a department, for example. The security policy is set for each organization. The content of the security policy may not necessarily be different among organizations.

In the above-described situation, it is necessary for the company of a user using a multifunction device in a remote working environment to check the security settings set for the multifunction device in advance. It may be possible to check the security settings by directly operating the multifunction device. However, remote working environments are usually set in multiple locations that are physically separated from the company. It takes a lot of time and effort to directly operate the multifunction device.

It may also be possible to check the security settings via a network. However, the company of a user and a remote working environment are separated on a network. To connect to the remote working environment, it may be necessary to use an unreliable network, which may lead to the falsification of data and fail to check the security settings.

An example of the technology for remotely checking whether a terminal is correctly operating as requested (that is, the authenticity of the terminal) is disclosed in Japanese Patent No. 5538132.

Usually, however, a multifunction device in a remote working environment is used among multiple users belonging to different companies, and the different companies have their own security policies. It can thus be assumed that the security settings for the multifunction device required by the individual companies are also different. The system disclosed in Japanese Patent No. 5538132 checks the authenticity of individual terminals based on the same condition. This system is unable to address the issue which may be posed in a situation where multiple users demand different security settings (that is, the conditions for the authenticity are different).

Additionally, the technologies disclosed in Japanese Patent Nos. 6318698 and 5538132 are based on the assumption that a terminal management server and a terminal are directly connected to each other via a network. To reduce the risk of security attacks against a multifunction device, many remote working environments prohibit direct access to a multifunction device from devices outside the remote working environment. It is thus difficult to connect a device that manages the security policy in the company of a user and the multifunction device in a remote working environment via a network.

The service providing device 120 in the exemplary embodiment has a function of checking whether security settings of the service providing device 120 satisfy a certain security policy, processing a checking result so that it will not be falsified even in an unreliable network, and sending the checking result. An information processing apparatus 100 in the exemplary embodiment has the following function. It is checked whether the security settings of the service providing device 120 conform to the security policy of the organization of a user of the information processing apparatus 100 without the need to directly connect a management device 180 of the organization of the user to the service providing device 120. Then, based on the checking result, it is determined whether it is safe to use the service providing device 120.

As an example of the system configuration of the exemplary embodiment, information processing apparatuses 100A1, 100A2, and 100B and the service providing device 120, for example, are connected to each other within a shared office 160 via a communication network 135. If it is not necessary to distinguish the information processing apparatuses 100A1, 100A2, and 100B from each other, they will collectively be called the information processing apparatus 100 or the information processing apparatuses 100. The information processing apparatus 100 is able to communicate with the management device 180 disposed outside the shared office 160 via a firewall device 140 and a communication network 190. The communication network 190 may be a wireless or wired medium, or a combination thereof, and may be, for example, the Internet as a communication infrastructure. The functions of the management device 180 may be implemented as cloud services. The communication network 135 may be a wireless or wired medium, or a combination thereof, and may be, for example, a local area network (LAN) as a communication infrastructure.

In this example, users belonging to different organizations are located in the shared office 160. For example, users A1 and A2 belonging to an organization A use the information processing apparatuses 100A1 and 100A2, respectively, while a user B belonging to an organization B uses the information processing apparatus 100B. The users within the shared office 160 are able to use the service providing device 120 by using the corresponding information processing apparatuses 100. For example, if the service providing device 120 is a multifunction device having a printer function, a user can print a document stored in the information processing apparatus 100 by using the service providing device 120.

To use the service providing device 120 by the user A1, for example, however, it is necessary that the service providing device 120 conform to the information protection policy of the organization A of the user A1. That is, even when a user is within the shared office 160, it ought to use the service providing device 120 that conforms to the information protection policy set by the organization of the user.

“Information protection policy” is a policy indicating the standards of information security measures for information resources in an organization, and is also typically called “security policy”. Examples of the information protection policy set by an organization are conditions concerning the authentication type, communication type, and whether the audit log for the service providing device 120 is required. If the service providing device 120 does not satisfy these conditions, a user belonging to this organization is not allowed to use the service providing device 120.

The information protection policy of an organization is managed by the management device of this organization. In the example in FIG. 1, an organization-A management device 180A manages the information protection policy of the organization A, while an organization-B management device 180B manages the information protection policy of the organization B.

Because of the provision of the firewall device 140, the management device 180 is unable to directly access the service providing device 120. In contrast, the information processing apparatus 100A1 is able to access the organization-A management device 180A of the organization A to which a user of the information processing apparatus 100A1 belongs. Hence, the information processing apparatus 100 obtains the security policy from the management device 180 managing the organization of the user of the information processing apparatus 100. The information processing apparatus 100 then causes the service providing device 120 to check whether it conforms to the security policy, and then determines whether it is safe to use the service providing device 120.

That is, even when the management device 180 and the service providing device 120 are remotely separated, the authenticity of the service providing device 120 based on the security policy can be checked.

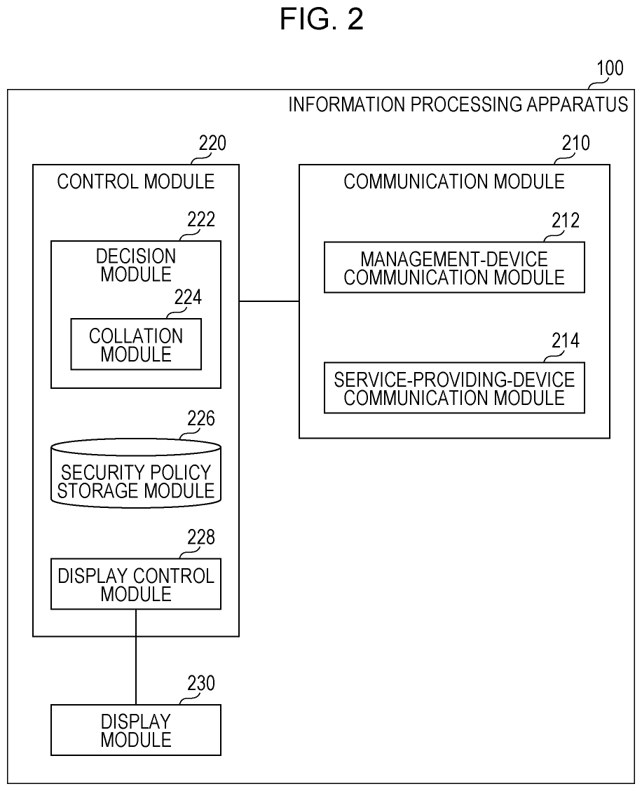

FIG. 2 is a block diagram illustrating conceptual modules forming an example of the configuration of the information processing apparatus 100 according to the exemplary embodiment.

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus (or a device) may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include a mere man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted. Examples of the storage device may be a hard disk drive, a random access memory (RAM), an external storage medium, a storage device using a communication network, and a register within a central processing unit (CPU).

As shown in FIG. 2, the information processing apparatus 10 includes a communication module 210, a control module 220, and a display module 230.

The communication module 210 is connected to the control module 220. The communication module 210 includes a management-device communication module 212 and a service-providing-device communication module 214. The communication module 210 communicates with the management device 180 and the service providing device 120.

As stated above, the management device 180 is unable to access the service providing device 120 because of the presence of the firewall device 140. Meanwhile, a user of the information processing apparatus 100 belongs to the organization of the management device 180 and is thus able to access the management device 180 by using the information processing apparatus 100. That is, as a result of the information processing apparatus 100 communicating with both the service providing device 120 and the management device 180, the management device 180 can check the information protection policy of the service providing device 120 and then determine whether it is safe to use the service providing device 120.

The management-device communication module 212 obtains the information protection policy from the management device 180.

The service-providing-device communication module 214 sends the information protection policy obtained from the management device 180 to the service providing device 120. The service-providing-device communication module 214 then receives from the service providing device 120 a collation result indicating whether the service providing device 120 conforms to the information protection policy.

The management-device communication module 212 then sends the collation result to the management device 180. As a response to the collation result, the management-device communication module 212 receives information that the service providing device 120 conforms to the information protection policy or information that the service providing device 120 does not conform to the information protection policy from the management device 180.

The control module 220 includes a decision module 222, a security policy storage module 226, and a display control module 228. The control module 220 is connected to the communication module 210.

The decision module 222 includes a collation module 224. When information that the service providing device 120 conforms to the information protection policy is received from the management device 180, the decision module 222 decides that it is possible to use the service providing device 120. When information that the service providing device 120 does not conform to the information protection policy is received from the management device 180, the decision module 222 decides that it is not possible to use the service providing device 120.

A judgement regarding whether the service providing device 120 conforms to the information protection policy of the management device 180 may be made by the collation module 224 of the information processing apparatus 100 instead of the service providing device 120. In this case, the collation module 224 executes the following processing.

The service-providing-device communication module 214 obtains the state of the service providing device 120 from the service providing device 120.

Then, the collation module 224 executes collation processing regarding whether the service providing device 120 conforms to the information protection policy by using the information protection policy and based on the state of the service providing device 120.

Then, the management-device communication module 212 sends the information protection policy and the collation result obtained by the collation module 224 to the management device 180.

Then, when the collation result from the collation module 224 indicates that the service providing device 120 conforms to the information protection policy, the decision module 222 decides that it is possible to use the service providing device 120. When the collation result from the collation module 224 indicates that the service providing device 120 does not conform to the information protection policy, the decision module 222 decides that it is not possible to use the service providing device 120. Alternatively, the decision module 222 may make a decision based on information received from the management device 180. If information that the service providing device 120 conforms to the information protection policy is received from the management device 180, the decision module 222 may decide that it is possible to use the service providing device 120. If information that the service providing device 120 does not conform to the information protection policy is received from the management device 180, the decision module 222 may decide that it is not possible to the service providing device 120.

Collation processing conducted by the service providing device 120 may be executed by the management device 180. More specifically, the service providing device 120 sends information indicating the state of the service providing device 120 to the management device 180. The management device 180 then conducts collation processing regarding whether the service providing device 120 conforms to the information protection policy by using the information protection policy and based on the state of the service providing device 120. The management device 180 returns a collation result to the service providing device 120.

The security policy storage module 226 stores the information protection policy obtained by the management-device communication module 212.

When the management-device communication module 212 tries to obtain the information protection policy from the management device 180 from the second time onwards, the information protection policy stored in the security policy storage module 226 may be used.

An expiration date may be set for the information protection policy.

In this case, if it is found based on the expiration date that the information protection policy stored in the security policy storage module 226 has expired, the management-device communication module 212 may obtain the latest information protection policy from the management device 180.

The information protection policy may be set for each service.

In this case, if a service A of the service providing device 120 requested from a user conforms to the information protection policy for the service A, the decision module 222 decides that it is possible to use the service A.

If it is determined based on the collation result that the service A of the service providing device 120 does not conform to the information protection policy for the service A, the service-providing-device communication module 214 may send the information protection policy for a service B, which is an alternative to the service A, to the service providing device 120.

For example, if a user has selected a fax function to send scanned data by fax but failed to use it because the fax function of the service providing device 120 does not conform to the information protection policy for the fax function, it is checked whether the “scan-to-email (sending a scanned image by email)” function, which is as an alternative to the “sending scanned data” function, conforms to the information protection policy for this function.

Even though the fax function of the service providing device 120 does not conform to the information protection policy for the fax function, the “scan-to-email” function may conform to the information protection policy for this function. The information processing apparatus 100 thus creates the information protection policy based on the “scan-to-email” function and sends it to the service providing device 120.

It is thus determined for each service whether a corresponding service provided by the service providing device 120 conforms to the information protection policy for this service.

If the service-providing-device communication module 214 has sent the information protection policy for the alternative service B to the service providing device 120, the management-device communication module 212 may send this information protection policy to the management device 180, together with a collation result indicating whether the service B conforms to the information protection policy.

If the collation result indicates that the service providing device 120 does not conform to the information protection policy, the control module 220 may perform control so that the service-providing-device communication module 214 replaces an item of the information protection policy that does not conform to the information protection policy of the management device 180 by an alternative item of the information protection policy, and sends the replaced information protection policy including the alternative item to the service providing device 120.

If the replaced information protection policy is sent to the service providing device 120, the control module 220 may perform control so that the management-device communication module 212 sends the replaced information protection policy to the management device 180, together with a collation result indicating whether the service providing device 120 conforms to the replaced information protection policy.

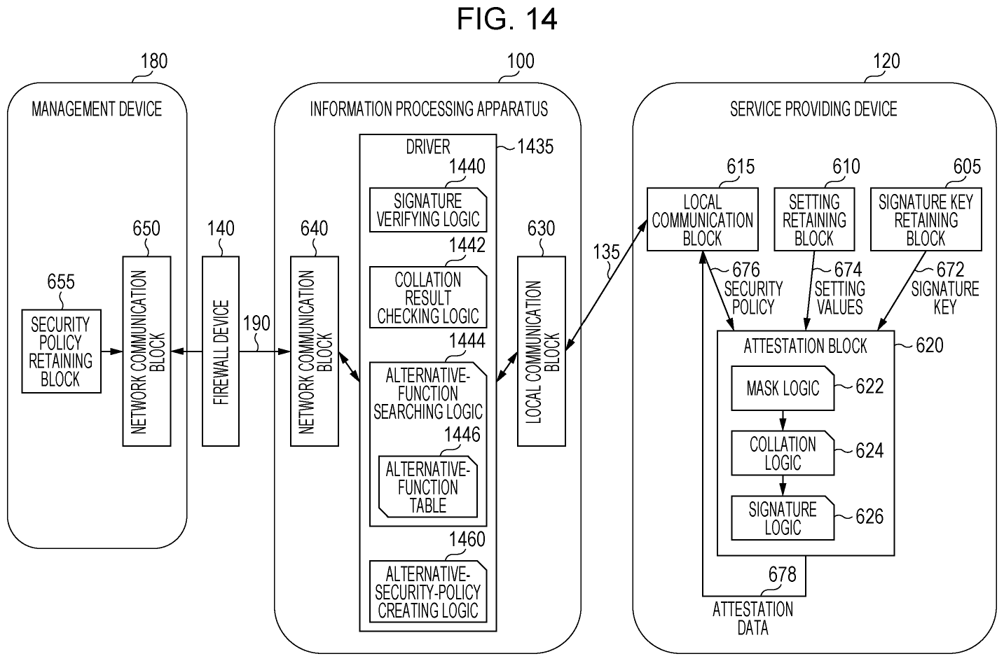

Details of replacement processing for the information protection policy will be discussed later with reference to FIGS. 14 through 17.

The display control module 228 is connected to the display module 230. The display control module 228 performs control so that the display module 230 displays a decision result of the decision module 222. For example, the display control module 228 causes the display module 230 to display that it is possible to use the service providing device 120 because it conforms to the information protection policy of the organization of a user using the service providing device 120 or that it is not possible to use the service providing device 120 because it does not conform to the information protection policy of the organization of a user using the service providing device 120.

The display module 230 is connected to the display control module 228 of the control module 220. The display module 230 is a display, such as a liquid crystal display or an organic electroluminescence (EL) display, and displays information under the control of the display control module 228. The display module 230 may receive an operation from a user, as in a touchscreen. For example, the display module 230 may receive an operation for using the service providing device 120 from a user. In response to receiving this operation, the information protection policy may be obtained from the management device 180 or the security policy storage module 226, and it may be judged whether the service providing device 120 conforms to the information protection policy.

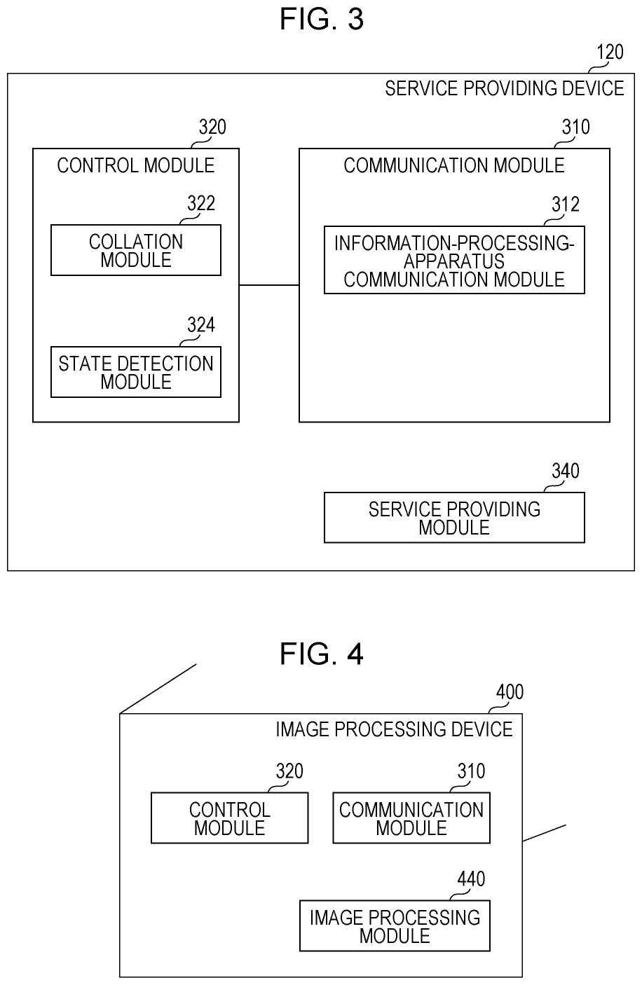

FIG. 3 is a block diagram illustrating conceptual modules forming an example of the configuration of the service providing device 120 according to the exemplary embodiment. The service providing device 120 has a function of providing a service to the information processing apparatus 100 or a user using the information processing apparatus 100. As shown in FIG. 3, the service providing device 120 includes a communication module 310, a control module 320, and a service providing module 340.

The communication module 310 is connected to the control module 320. The communication module 310 includes an information-processing-apparatus communication module 312, and communicates with the information processing apparatus 100.

The information-processing-apparatus communication module 312 obtains the information protection policy from the management device 180 via the information processing apparatus 100.

The information-processing-apparatus communication module 312 then sends a collation result obtained from a collation module 322 of the control module 320 to the information processing apparatus 100. The collation result from the collation module 322 indicates whether the service providing device 120 conforms to the information protection policy.

The control module 320 includes the collation module 322 and a state detection module 324. The control module 320 is connected to the communication module 310.

The state detection module 324 detects the state of the service providing device 120 in terms of the information protection policy, and supplies the detection result to the collation module 322. For example, if the authentication type is described in the information protection policy, the state detection module 324 detects the authentication type of the service providing device 120.

The collation module 322 executes collation processing by using the detection result supplied from the state detection module 324 to judge whether the service providing device 120 conforms to the information protection policy.

The service providing module 340 provides a service to the information processing apparatus 100 or a user. For example, the service providing module 340 may provide a service as a multifunction device, as in an image processing module 440 shown in FIG. 4, or provide a service for storing a document or a website service, for example.

FIG. 4 is a block diagram illustrating conceptual modules forming an example of the configuration of an image processing device 400 used as the service providing device 120.

The image processing device 400 includes a communication module 310, a control module 320, and the image processing module 440.

The image processing module 440 is an example of the service providing module 340. The image processing module 440 executes processing as a print function, a copy function, a scan function, a fax function, a character recognition function, and the above-described scan-to-email function, for example.

For example, the image processing device 400 is installed in the shared office 160 and is available for a user. As a specific example, the image processing device 400 provides a service, such as printing a document, in response to a print instruction from the information processing apparatus 100. However, unless the image processing device 400 conforms to the security policy of the organization of a user, the user is not allowed to use a service of the image processing device 400. In the exemplary embodiment, upon receiving an instruction to use a service of the image processing device 400, the information processing apparatus 100 obtains the security policy from the management device 180 that manages the security policy of the organization of the user. The information processing apparatus 100 then judges whether the image processing device 400 conforms to the security policy, and if it is found that the image processing device 400 does not conform to the security policy, the information processing apparatus 100 changes the settings of the image processing device 400 so that the user can use a service of the image processing device 400. When the information processing apparatus 100 has changed the settings of the image processing device 400, the previous settings may be resumed after the service has been provided to the information processing apparatus 100.

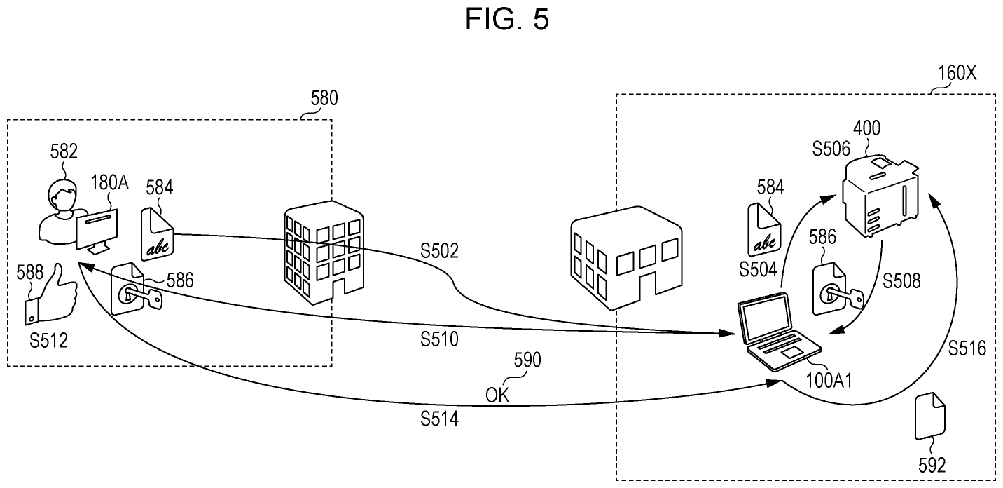

FIG. 5 illustrates an example of processing executed in the exemplary embodiment.

In a shared office 160X, a user of the information processing apparatus 100A1 tries to use the image processing device 400. This user belongs to an organization A 580. In this situation, processing performed among the information processing apparatus 100A1 and the image processing device 400 within the shared office 160X and the organization-A management device 180A within the organization A 580 will be described below by way of example. In this example, it is assumed that the image processing device 400 conforms to the security policy of the organization A 580.

In step S502, the information processing apparatus 100A1 downloads a security policy 584 from the organization-A management device 180A of the organization A 580.

In step S504, the information processing apparatus 100A1 sends the security policy 584 obtained in step S502 to the image processing device 400.

In step S506, the image processing device 400 checks its internal state and settings in accordance with the security policy 584.

In step S508, the image processing device 400 attaches a signature to the checking result obtained in step S506, generates attestation data 586, and returns it to the information processing apparatus 100A1.

In step S510, the information processing apparatus 100A1 transfers the attestation data 586 to the organization-A management device 180A of the organization A 580.

In step S512, the organization-A management device 180A executes verification processing 588 on the attestation data 586. More specifically, the organization-A management device 180A checks the signature of the image processing device 400 attached to the attestation data 586 and verifies whether the internal state and the settings of the image processing device 400 conform to the security policy 584.

In step S514, the organization-A management device 180A sends a verification result (OK) 590 to the information processing apparatus 100A1.

In step S516, the information processing apparatus 100A1 receives the verification result (OK) 590 and becomes ready to use the image processing device 400. For example, the information processing apparatus 100A1 can print a document 592 by using the image processing device 400.

The organization-A management device 180A may execute the above-described processing singly or together with an operation or a judgement of an organization-A administrator 582.

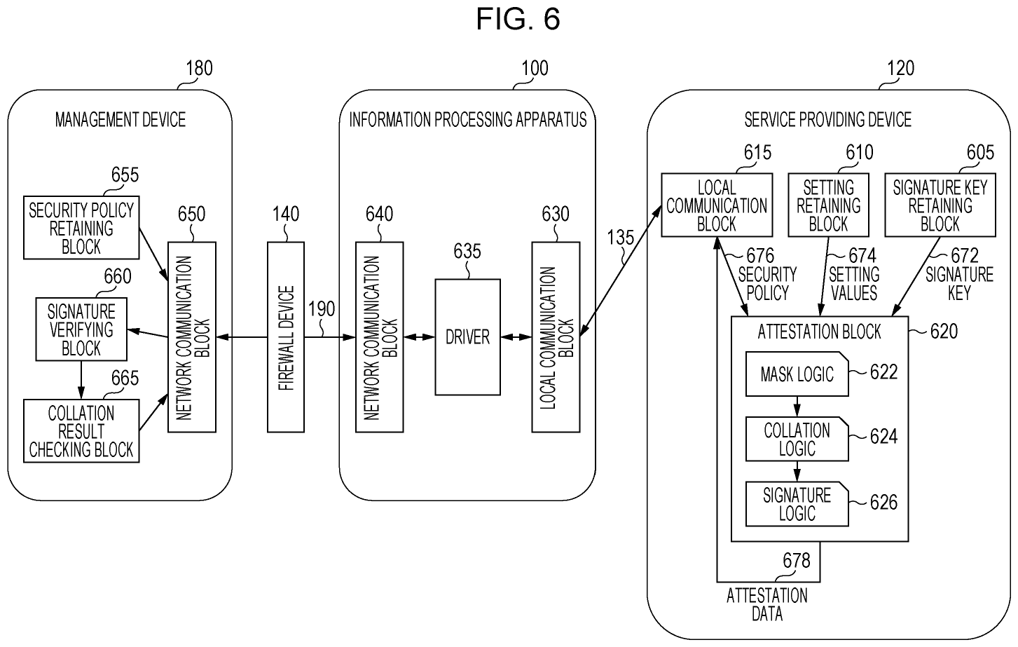

FIG. 6 is a schematic diagram of specific modules forming an example of the configuration of the exemplary embodiment.

In the example in FIG. 6, it is assumed that the management device 180 and the information processing apparatus 100 belong to the same company (an example of the organization) and the service providing device 120 belongs to a different company. The information processing apparatus 100 and the service providing device 120 are within the shared office 160 and are protected by the firewall device 140. The information processing apparatus 100 accesses the management device 180 via the firewall device 140.

The management device 180 includes a network communication block 650, a security policy retaining block 655, a signature verifying block 660, a collation result checking block 665.

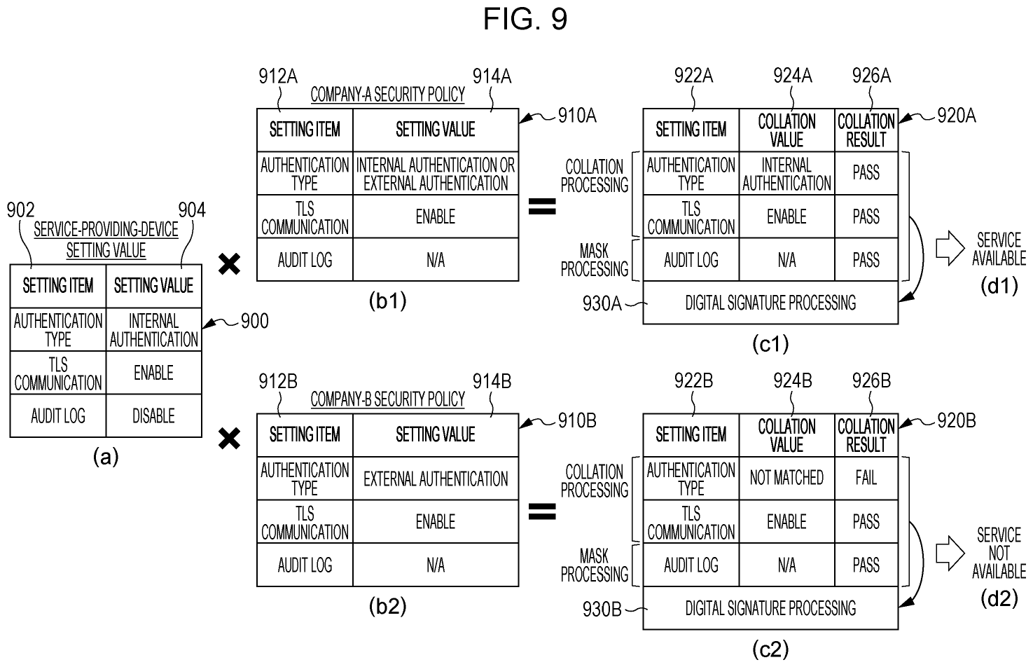

The security policy retaining block 655 is connected to the network communication block 650. The security policy retaining block 655 retains a security policy. The security policy demands one or multiple setting values for each setting item or retains information indicating that no particular value is required (not applicable (N/A)), that is, a masked item, as indicated by a security policy table 910, which will be discussed in detail with reference to FIG. 9.

The signature verifying block 660 is connected to the network communication block 650 and the collation result checking block 665. The signature verifying block 660 verifies a digital signature attached to a collation result generated by the service providing device 120 with a private key. In this case, the signature verifying block 660 verifies the digital signature by using the public key associated with the private key to check the authenticity of the digital signature.

The collation result checking block 665 is connected to the network communication block 650 and the signature verifying block 660. The collation result checking block 665 judges whether it is possible to use the service providing device 120, based on the collation result.

The network communication block 650 is connected to the security policy retaining block 655, the signature verifying block 660, and the collation result checking block 665. The network communication block 650 is connected to a network communication block 640 of the information processing apparatus 100 via the firewall device 140 and the communication network 190. The network communication block 650 communicates with the information processing apparatus 100 via the communication network 190.

The information processing apparatus 100 includes a local communication block 630, a driver 635, and the network communication block 640.

The network communication block 640 is connected to the driver 635, and is also connected to the network communication block 650 of the management device 180 via the communication network 190 and the firewall device 140. The network communication block 640 communicates with the management device 180 via the communication network 190.

The driver 635 is connected to the local communication block 630 and the network communication block 640. The driver 635 provides a function for using the service providing device 120 to a user. The driver 635 controls the provision of this function to a user in accordance with a judging result regarding whether it is possible to use the service providing device 120, which is obtained from the management device 180.

The local communication block 630 is connected to the driver 635, and is also connected to a local communication block 615 of the service providing device 120 via the communication network 135. The local communication block 630 communicates with the service providing device 120.

The service providing device 120 includes a signature key retaining block 605, a setting retaining block 610, the local communication block 615, and an attestation block 620.

The local communication block 615 is connected to the attestation block 620, and is also connected to the local communication block 630 of the information processing apparatus 100 via the communication network 135. The local communication block 615 communicates with the information processing apparatus 100. More specifically, the local communication block 615 supplies a security policy 676 to the attestation block 620 and receives attestation data 678 from the attestation block 620.

The setting retaining block 610 is connected to the attestation block 620. The setting retaining block 610 retains setting values of the service providing device 120. The setting retaining block 610 supplies setting values 674 to the attestation block 620 in accordance with the reading from the attestation block 620.

The signature key retaining block 605 is connected to the attestation block 620. The signature key retaining block 605 retains a signature key (more specifically, a private key) for attaching a signature to a collation result. The signature key retaining block 605 supplies a signature key 672 to the attestation block 620.

The attestation block 620 includes a mask logic 622, a collation logic 624, and a signature logic 626. The attestation block 620 is connected to the signature key retaining block 605, the setting retaining block 610, and the local communication block 615. The attestation block 620 collates the security policy 676 received from the local communication block 615 with the setting values 674 of the service providing device 120 read from the setting retaining block 610. The attestation block 620 then attaches a signature to the collation result with the signature key 672 stored in the signature key retaining block 605, thereby proving the conformity to the security policy 676 (the authenticity of the service providing device 120). That is, the attestation block 620 conducts attestation processing. More specifically, the attestation block 620 receives the signature key 672 from the signature key retaining block 605, the setting values 674 from the setting retaining block 610, and the security policy 676 from the local communication block 615, and then supplies the attestation data 678 to the local communication block 615.

The mask logic 622 is connected to the collation logic 624. The mask logic 622 selects a setting value 674 to be collated in accordance with the security policy 676.

The collation logic 624 is connected to the mask logic 622 and the signature logic 626. The collation logic 624 compares the setting value 674 of an unmasked item with a value demanded by the security policy 676.

The signature logic 626 is connected to the collation logic 624. The signature logic 626 attaches a digital signature to the collation result by using the signature key 672.

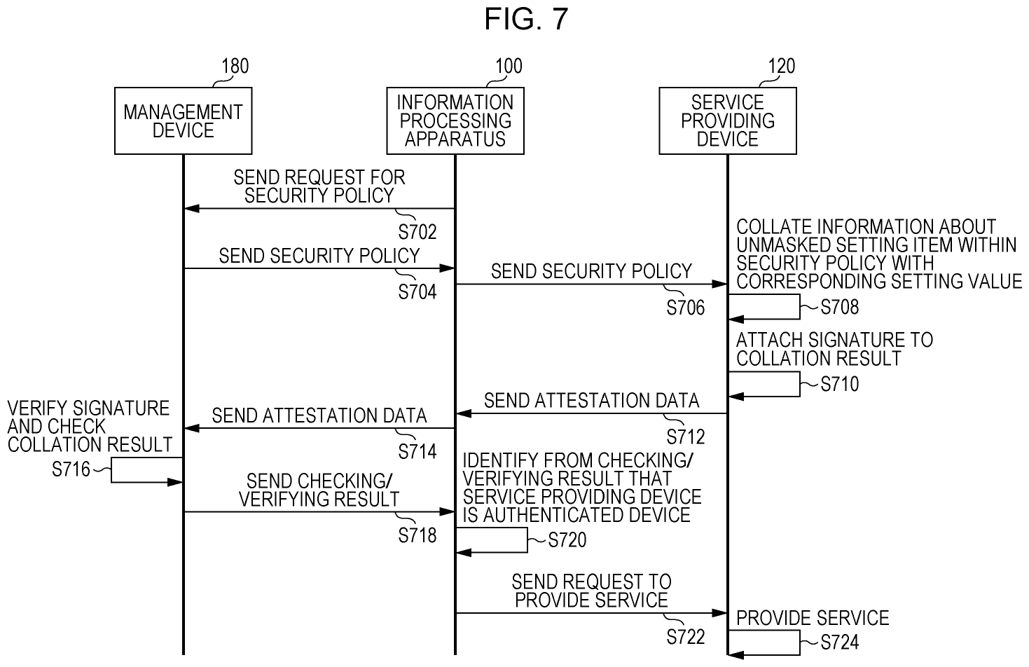

FIG. 7 is a flowchart illustrating an example of processing executed in the exemplary embodiment. The processing in FIG. 7 is executed by the configuration shown in FIG. 6.

In step S702, the information processing apparatus 100 requests the management device 180 to send the security policy.

In step S704, the management device 180 sends the security policy to the information processing apparatus 100.

In step S706, the information processing apparatus 100 sends the security policy to the service providing device 120.

In steps S702 through S706, in response to a request to provide a service from a user, for example, the information processing apparatus 100 obtains the security policy from the management device 180 and sends it to the service providing device 120.

In step S708, the service providing device 120 executes collation processing to collate information about an unmasked setting item within the security policy with the corresponding setting value of the service providing device 120. Details of step S708 will be discussed later with reference to FIG. 9.

In step S710, the service providing device 120 attaches a signature to the collation result and generates attestation data.

In step S712, the service providing device 120 sends the attestation data to the information processing apparatus 100.

In step S714, the information processing apparatus 100 sends the attestation data to the management device 180.

In step S716, the management device 180 verifies the signature and checks the collation result.

In step S718, the management device 180 sends the checking/verifying result to the information processing apparatus 100.

In step S720, the information processing apparatus 100 identifies based on the checking/verifying result that the service providing device 120 is an authenticated device.

In step S722, the information processing apparatus 100 sends the request to provide a service to the service providing device 120.

In step S724, the service providing device 120 provides a service.

In steps S712 through S724, the management device 180 verifies the signature appended to the attestation data generated after steps S708 and S710 and checks the collation result, judges whether it is possible to use a service provided by the service providing device 120 (“service available”), and sends a checking/verifying result to the information processing apparatus 100. If it is found that it is possible to use a service, the information processing apparatus 100 sends a service request received from a user to the service providing device 120, based on the checking/verifying result. If it is found that it is not possible to use a service, the information processing apparatus 100 informs the user that a service is not available, based on the checking/verifying result.

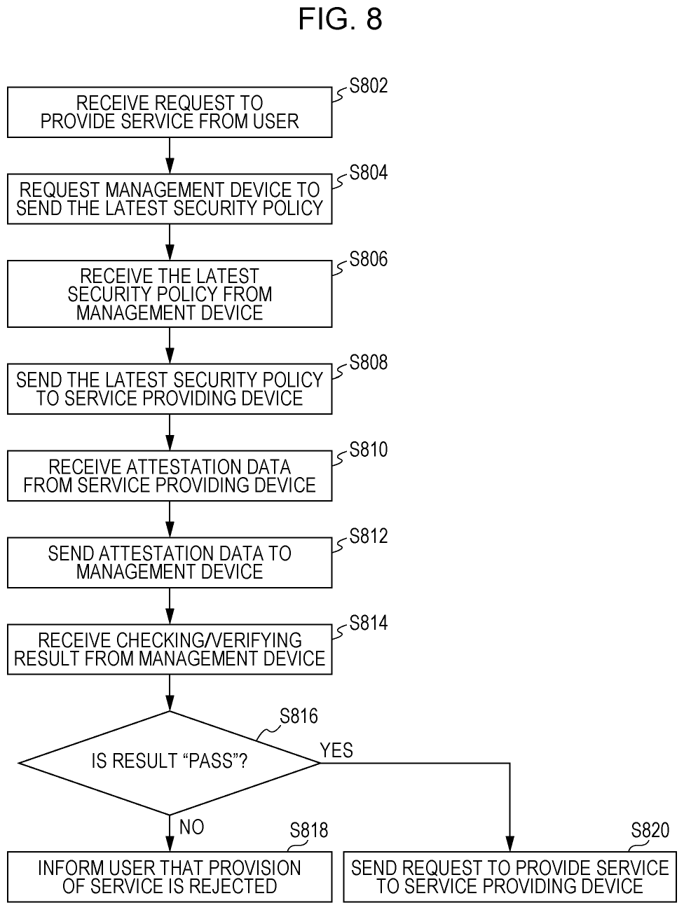

FIG. 8 is a flowchart illustrating an example of processing executed in the exemplary embodiment. The processing in FIG. 8 is the processing in FIG. 7 from the viewpoint of the information processing apparatus 100.

In step S802, the information processing apparatus 100 receives a request to provide a service from a user.

In step S804, the information processing apparatus 100 requests the management device 180 to send the latest security policy.

In step S806, the information processing apparatus 100 receives the latest security policy from the management device 180.

In step S808, the information processing apparatus 100 sends the latest security policy to the service providing device 120.

In step S810, the information processing apparatus 100 receives attestation data from the service providing device 120.

In step S812, the information processing apparatus 100 sends the attestation data to the management device 180.

In step S814, the information processing apparatus 100 receives a checking/verifying result from the management device 180.

In step S816, the information processing apparatus 100 judges whether the checking/verifying result is “PASS” or “FAIL”. If the checking/verifying result is “PASS”, the information processing apparatus 100 proceeds to step S820. If the checking/verifying result is “FAIL”, the information processing apparatus 100 proceeds to step S818.

In step S818, the information processing apparatus 100 informs the user that the provision of a service is rejected.

In step S820, the information processing apparatus 100 sends the request to provide a service to the service providing device 120.

FIG. 9 illustrates an example of processing executed in the exemplary embodiment. FIG. 9 illustrates an example of detailed processing of step S708 in FIG. 7. More specifically, FIG. 9 illustrates an implementation example of attestation processing executed by the attestation block 620 (mask processing by the mask logic 622, collation processing by the collation logic 624, and signature processing by the signature logic 626) in the service providing device 120.

An example of processing in company A will first be discussed below through illustration of the procedure of (a), (b1), (c1), and (d1) of FIG. 9.

In FIG. 9, (a) shows an example of the data structure of a service-providing-device setting value table 900. The service-providing-device setting value table 900 indicates setting values of the service providing device 120 and is stored in the setting retaining block 610 of the service providing device 120.

The service-providing-device setting value table 900 has a setting item field 902 and a setting value field 904. The setting item field 902 stores setting items. The setting value field 904 stores setting values of the service providing device 120 associated with the individual setting items.

For example, in the service-providing-device setting value table 900, “internal authentication” is set as the authentication type, “enable” is set as transport layer security (TLS) communication, and “disable” is set as the audit log.

In FIG. 9, (b1) shows an example of the data structure of a company-A security policy table 910A, that is, the security policy of company A.

The company-A security policy table 910A has a setting item field 912A and a setting value field 914A. The setting item field 912A stores setting items. The setting value field 914A stores setting values associated with the individual setting items.

For example, in the company-A security policy table 910A, “internal authentication or external authentication” is set as the authentication type, “enable” is set as TLS communication, and “N/A” is set as the audit log.

In this example, a collation result (attestation data) appended with a signature is generated for the company-A security policy table 910A by the following processing.

### Mask Processing by Mask Logic 622

The audit log field (third row in the company-A security policy table 910A) is masked (N/A), and the collation result is accordingly “PASS” regardless of the setting value.

### Collation Processing by Collation Logic 624

The TLS communication field (second row in the company-A security policy table 910A) indicates “enable”. The setting value of the service providing device 120 (second row in the service-providing-device setting value table 900) is also “enable”. The collation result is accordingly “PASS”.

The authentication type field (first row in the company-A security policy table 910A) indicates “internal authentication or external authentication”. The setting value of the service providing device 120 (first row in the service-providing-device setting value table 900) is “internal authentication”. The collation result is accordingly “PASS”.

As a result of the above-described processing, a collation result table 920A is generated. In FIG. 9, (c1) shows an example of the data structure of the collation result table 920A. The collation result table 920A has a setting item field 922A, a collation value field 924A, and a collation result field 926A. The setting item field 922A stores setting items. The collation value field 924A stores the collation values associated with the individual setting items. The collation result field 926A stores the collation results associated with the individual setting items. For example, the first row of the collation result table 920A shows that, regarding the authentication type in the setting item field 922A, the collation value field 924A indicates “internal authentication” and the collation result field 926A indicates “PASS”. The second row of the collation result table 920A shows that, regarding TLS communication in the setting item field 922A, the collation value field 924A indicates “enable” and the collation result field 926A indicates “PASS”. The third row of the collation result table 920A shows that, regarding the audit log in the setting item field 922A, the collation value field 924A indicates “N/A” and the collation result field 926A indicates “PASS”.

### Signature Processing by Signature Logic 626

As a result of attaching a digital signature to the entirety of the above-described collation result, it is possible to detect the falsification of the collation result in a communication path. In the example in (c1), digital signature processing 930A is executed on the collation result table 920A.

Regarding the attestation data generated by the above-described procedure, the signature is verified and the collation result is checked in the organization-A management device 180A. The organization-A management device 180A then determines that it is possible to use a service of the service providing device 120 (“service available”), as shown in (d1). The checking/verifying result is then sent to the information processing apparatus 100.

The information processing apparatus 100 sends a service request received from a user to the service providing device 120, based on the checking/verifying data.

An example of processing in company B will now be discussed below through illustration of the procedure of (a), (b2), (c2), and (d2) of FIG. 9.

In FIG. 9, (b2) shows an example of the data structure of a company-B security policy table 910B, that is, the security policy of company B.

The company-B security policy table 910B has a setting item field 912B and a setting value field 914B. The setting item field 912B stores setting items. The setting value field 914B stores setting values associated with the individual setting items.

For example, in the company-B security policy table 910B, “external authentication” is set as the authentication type, “enable” is set as TLS communication, and “N/A” is set as the audit log.

In this example, a collation result (attestation data) appended with a signature is generated for the company-B security policy table 910B by the following processing.

### Mask Processing by Mask Logic 622

The audit log field (third row in the company-B security policy table 910B) is masked (N/A), and the collation result is accordingly “PASS” regardless of the setting value.

### Collation Processing by Collation Logic 624

The TLS communication field (second row in the company-B security policy table 910B) indicates “enable”. The setting value of the service providing device 120 (second row in the service-providing-device setting value table 900) is also “enable”. The collation result is accordingly “PASS”.

The authentication type field (first row in the company-B security policy table 910B) indicates “external authentication”. The setting value of the service providing device 120 (first row in the service-providing-device setting value table 900) is “internal authentication”. The collation result is accordingly “FAIL”.

As a result of the above-described processing, a collation result table 920B is generated. In FIG. 9, (c2) shows an example of the data structure of the collation result table 920B. The collation result table 920B has a setting item field 922B, a collation value field 924B, and a collation result field 926B. The setting item field 922B stores setting items. The collation value field 924B stores the collation values associated with the individual setting items. The collation result field 926B stores the collation results associated with the individual setting items. For example, the first row of the collation result table 920B shows that, regarding the authentication type in the setting item field 922B, the collation value field 924B indicates “not matched” and the collation result field 926B indicates “FAIL”. The second row of the collation result table 920B shows that, regarding TLS communication in the setting item field 922B, the collation value field 924B indicates “enable” and the collation result field 926B indicates “PASS”. The third row of the collation result table 920B shows that, regarding the audit log in the setting item field 922B, the collation value field 924B indicates “N/A” and the collation result field 926B indicates “PASS”.

### Signature Processing by Signature Logic 626

As a result of attaching a digital signature to the entirety of the above-described collation result, it is possible to detect the falsification of the collation result in a communication path. In the example in (c2), digital signature processing 930B is executed on the collation result table 920B.

Regarding the attestation data generated by the above-described procedure, the signature is verified and the collation result is checked in the organization-B management device 180B. The organization-B management device 180B then determines that it is not possible to use a service of the service providing device 120 (“service not available”), as shown in (d2). The checking/verifying result is then sent to the information processing apparatus 100.

Based on the checking/verifying result, the information processing apparatus 100 informs the user that a service is not available.

A description will be given of an example in which checking processing for attestation data is executed by the information processing apparatus 100 instead of the management device 180.

In the above-described processing example, every time a request to provide a service is received from a user, the following communication is made between the information processing apparatus 100 and the management device 180, and then, the request is sent to the service providing device 120.
Sending of the security policy (from the management device 180 to the information processing apparatus 100)
Sending of attestation data (from the information processing apparatus 100 to the management device 180)
Sending of a checking/verifying result (from the management device 180 to the information processing apparatus 100)

The above-described communication processing is most likely to increase the time needed to provide a service to a user. A failure of communication may also occur.

The following processing may be executed alternatively.

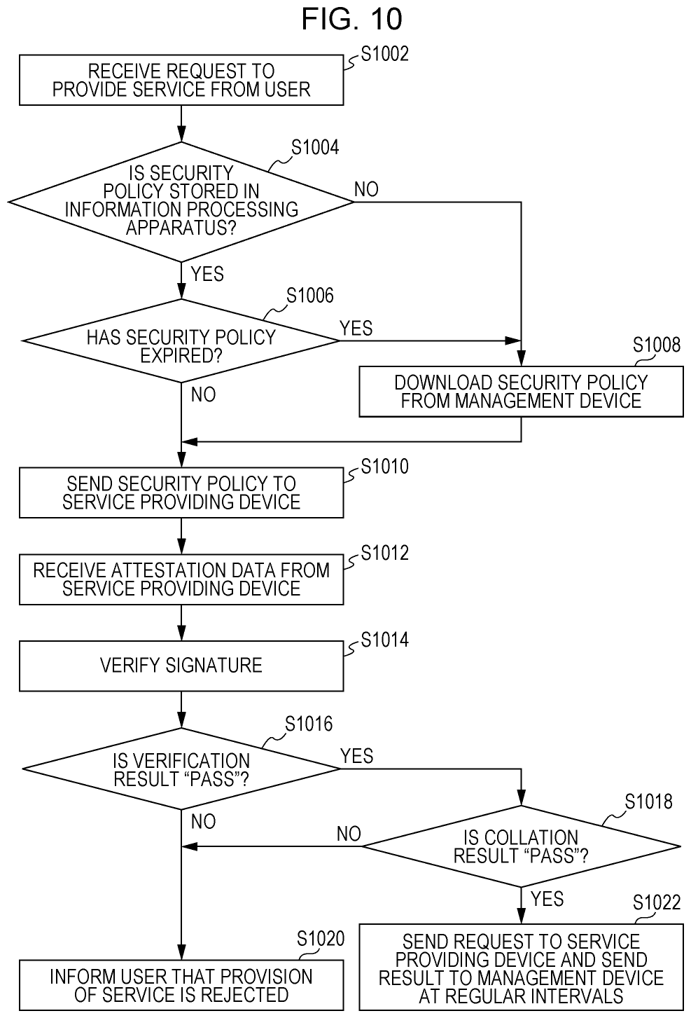

FIG. 10 is a flowchart illustrating an example of processing executed in the exemplary embodiment in terms of the information processing apparatus 100.

In step S1002, the information processing apparatus 100 receives a request to provide a service from a user.

In step S1004, the information processing apparatus 100 judges whether the security policy of the organization of the user is stored in the information processing apparatus 100. If the security policy is stored, the information processing apparatus 100 proceeds to step S1006. If the security policy is not stored, the information processing apparatus 100 proceeds to step S1008.

In step S1006, the information processing apparatus 100 judges whether the security policy has expired. If the security policy has expired, the information processing apparatus 100 proceeds to step S1008. If the security policy has not expired, the information processing apparatus 100 proceeds to step S1010.

In step S1008, the information processing apparatus 100 downloads the security policy from the management device 180.

In step S1010, the information processing apparatus 100 sends the security policy to the service providing device 120.

In step S1012, the information processing apparatus 100 receives attestation data from the service providing device 120.

In step S1014, the information processing apparatus 100 verifies a signature attached to the attestation data.

In step S1016, the information processing apparatus 100 judges whether the verification result is “PASS”. If the verification result is “PASS”, the information processing apparatus 100 proceeds to step S1018. If the verification result is not “PASS”, the information processing apparatus 100 proceeds to step S1020.

In step S1018, the information processing apparatus 100 judges whether the collation result is “PASS”. If the collation result is “PASS”, the information processing apparatus 100 proceeds to step S1022. If the collation result is not “PASS”, the information processing apparatus 100 proceeds to step S1020.

In step S1020, the information processing apparatus 100 informs the user that the provision of a service is rejected.

In step S1022, the information processing apparatus 100 sends the service request to the service providing device 120, and sends the result to the management device 180 at regular intervals.

The processing in FIG. 10 is different from that in FIG. 7 or FIG. 8 in the following points.
Instead of downloading the security policy from the management device 180 every time a request to provide a service is received from a user, the information processing apparatus 100 stores the security policy therein for a certain period.
The information processing apparatus 100 verifies the signature and checks the collation result of attestation data by itself.

It may be possible that the security policy in the management device 180 be updated, in which case, the security policy stored in the information processing apparatus 100 becomes inconsistent with the updated security policy in the management device 180. To deal with this situation, the expiration date may be set for the security policy so as to prevent the use of the expired security policy in the information processing apparatus 100.

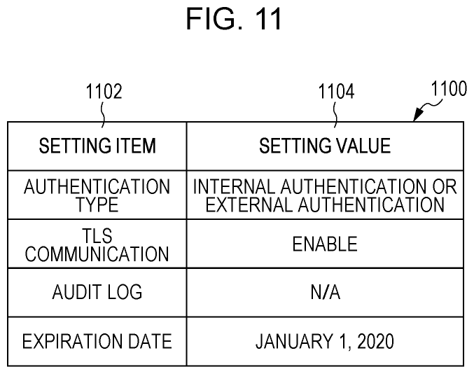

More specifically, a security policy table 1100 may be used. FIG. 11 illustrates an example of the data structure of the security policy table 1100. The security policy table 1100 has a setting item field 1102 and a setting value field 1104. The setting item field 1102 stores setting items. The setting value field 1104 stores setting values associated with the individual setting items. An expiration date field is provided in the security policy table 1100 so as to manage the period for which the security policy table 1100 can be used.

In the security policy table 1100, as the authentication type, “internal authentication or external authentication” is set, as TLS communication, “enable” is set, as the audit log, “N/A” is set, and as the expiration date, “Jan. 1, 2020” is set. That is, the information processing apparatus 100 can execute processing by using the security policy table 1100 until Jan. 1, 2020.

A log for the verification of the signature and the checking of the collation result in the attestation data executed in the information processing apparatus 100 may be sent to the management device 180 at regular intervals. This log enables the management device 180 to check whether the security policy is suitably applied.

The security policy may be set for each function group. It may be possible that the service providing device 120 provide multiple services. The required security level may be different among the services provided by the service providing device 120.

In the above-described processing, however, each organization has only one security policy, and applies this most demanding security policy to all services. This limits the use of services which do not require a high level of security.

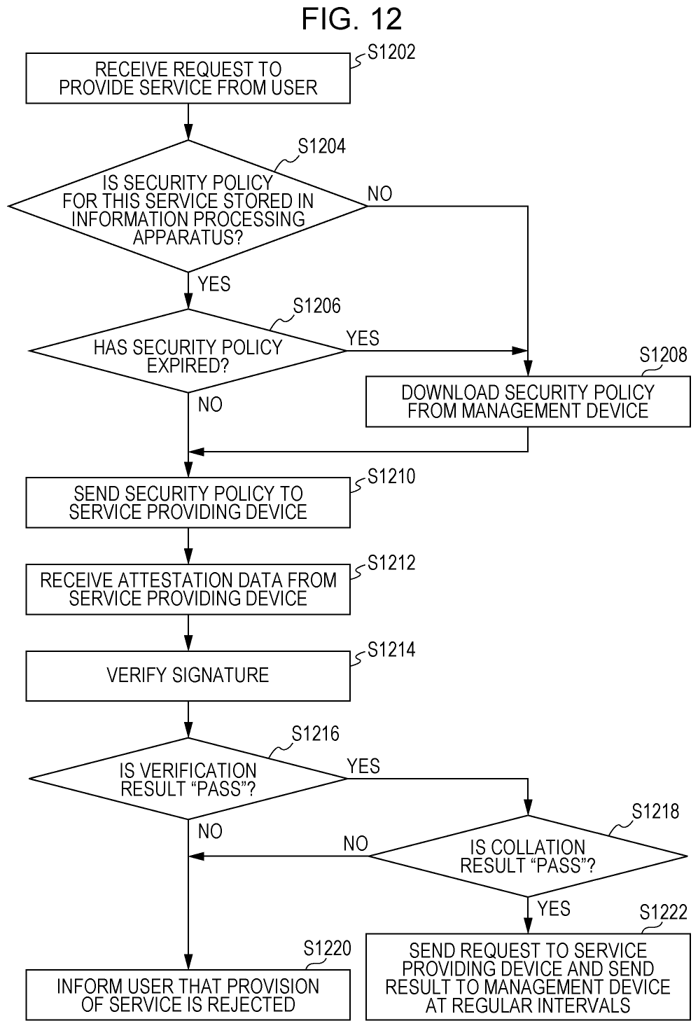

To address this issue, processing shown in FIG. 12 may be executed alternatively. FIG. 12 is a flowchart illustrating an example of processing executed in the exemplary embodiment in terms of the information processing apparatus 100.

In step S1202, the information processing apparatus 100 receives a request to provide a service from a user.

In step S1204, the information processing apparatus 100 judges whether the security policy for this service is stored in the information processing apparatus 100. If the security policy is stored, the information processing apparatus 100 proceeds to step S1206. If the security policy is not stored, the information processing apparatus 100 proceeds to step S1208.

In step S1206, the information processing apparatus 100 judges whether the security policy has expired. If the security policy has expired, the information processing apparatus 100 proceeds to step S1208. If the security policy has not expired, the information processing apparatus 100 proceeds to step S1210.

In step S1208, the information processing apparatus 100 downloads the security policy from the management device 180.

In step S1210, the information processing apparatus 100 sends the security policy to the service providing device 120.

In step S1212, the information processing apparatus 100 receives attestation data from the service providing device 120.

In step S1214, the information processing apparatus 100 verifies a signature attached to the attestation data.

In step S1216, the information processing apparatus 100 judges whether the verification result is “PASS”. If the verification result is “PASS”, the information processing apparatus 100 proceeds to step S1218. If the verification result is not “PASS”, the information processing apparatus 100 proceeds to step S1220.

In step S1218, the information processing apparatus 100 judges whether the collation result is “PASS”. If the collation result is “PASS”, the information processing apparatus 100 proceeds to step S1222. If the collation result is not “PASS”, the information processing apparatus 100 proceeds to step S1220.

In step S1220, the information processing apparatus 100 informs the user that the provision of the service is rejected.

In step S1222, the information processing apparatus 100 sends the service request to the service providing device 120, and sends the result to the management device 180 at regular intervals.

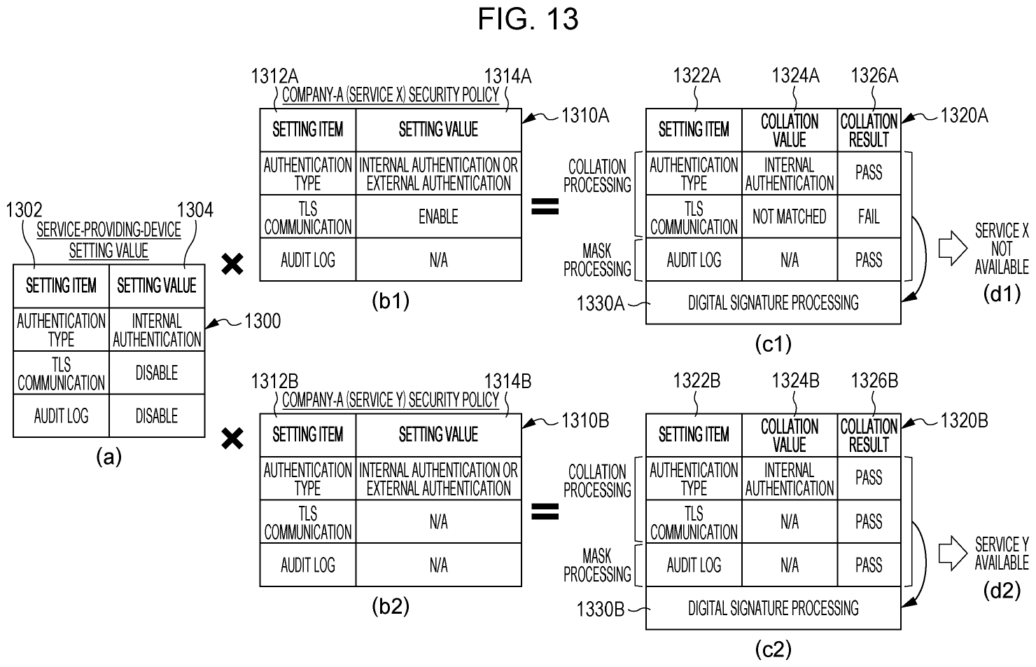

FIG. 13 illustrates an example of processing executed in the exemplary embodiment based on the flowchart of FIG. 12.

In FIG. 13, (a) shows an example of the data structure of a service-providing-device setting value table 1300. The service-providing-device setting value table 1300 indicates setting values of the service providing device 120 and is stored in the setting retaining block 610 of the service providing device 120.

The service-providing-device setting value table 1300 has a setting item field 1302 and a setting value field 1304. The setting item field 1302 stores setting items. The setting value field 1304 stores setting values of the service providing device 120 associated with the individual setting items.

For example, in the service-providing-device setting value table 1300, “internal authentication” is set as the authentication type, “disable” is set as TLS communication, and “disable” is set as the audit log.

In FIG. 13, (b1) shows an example of the data structure of a company-A (service X) security policy table 1310A, that is, the security policy for the service X in company A.

The company-A (service X) security policy table 1310A has a setting item field 1312A and a setting value field 1314A. The setting item field 1312A stores setting items. The setting value field 1314A stores setting values associated with the individual setting items.

For example, in the company-A (service X) security policy table 1310A, “internal authentication or external authentication” is set as the authentication type, “enable” is set as TLS communication, and “N/A” is set as the audit log.

In FIG. 13, (b2) shows an example of the data structure of a company-A (service Y) security policy table 1310B, that is, the security policy for the service Y in company A.

The company-A (service Y) security policy table 1310B has a setting item field 1312B and a setting value field 1314B. The setting item field 1312B stores setting items. The setting value field 1314B stores setting values associated with the individual setting items.

For example, in the company-A (service Y) security policy table 1310B, “internal authentication or external authentication” is set as the authentication type, “N/A” is set as TLS communication, and “N/A” is set as the audit log.

As a result of executing mask processing by the mask logic 622 and collation processing by the collation logic 624, collation result tables 1320A and 1320B are generated.

In FIG. 13, (c1) shows an example of the data structure of the collation result table 1320A. The collation result table 1320A has a setting item field 1322A, a collation value field 1324A, and a collation result field 1326A. The setting item field 1322A stores setting items. The collation value field 1324A stores the collation values associated with the individual setting items. The collation result field 1326A stores the collation results associated with the individual setting items.

For example, the first row of the collation result table 1320A shows that, regarding the authentication type in the setting item field 1322A, the collation value field 1324A indicates “internal authentication” and the collation result field 1326A indicates “PASS”. The second row of the collation result table 1320A shows that, regarding TLS communication in the setting item field 1322A, the collation value field 1324A indicates “not matched” and the collation result field 1326A indicates “FAIL”. The third row of the collation result table 1320A shows that, regarding the audit log in the setting item field 1322A, the collation value field 1324A indicates “N/A” and the collation result field 1326A indicates “PASS”.

The signature logic 626 executes digital signature processing 1330A on the collation result table 1320A.

In FIG. 13, (c2) shows an example of the data structure of the collation result table 1320B. The collation result table 1320B has a setting item field 1322B, a collation value field 1324B, and a collation result field 1326B. The setting item field 1322B stores setting items. The collation value field 1324B stores the collation values associated with the individual setting items. The collation result field 1326B stores the collation results associated with the individual setting items.

For example, the first row of the collation result table 1320B shows that, regarding the authentication type in the setting item field 1322B, the collation value field 1324B indicates “internal authentication” and the collation result field 1326B indicates “PASS”. The second row of the collation result table 1320B shows that, regarding TLS communication in the setting item field 1322B, the collation value field 1324B indicates “N/A” and the collation result field 1326B indicates “PASS”. The third row of the collation result table 1320B shows that, regarding the audit log in the setting item field 1322B, the collation value field 1324B indicates “N/A” and the collation result field 1326B indicates “PASS”.

The signature logic 626 executes digital signature processing 1330B on the collation result table 1320B.

In this example, regarding the authentication type, internal authentication or external authentication is required for both the service X and the service Y. TLS communication, however, is required for only the service X involving external data communication, but is not required for the service Y which does not involve external data communication (the second row of TLS communication of the company-A (service Y) security policy table 1310B indicates “N/A”). In the service-providing-device setting value table 1300 of the service providing device 120, TLS communication is “disable”. As indicated in (d1) in FIG. 13, it is not possible to use the service X (“service X not available”), whereas the service Y can be used (“service Y available”) as indicated in (d2) in FIG. 13.

In the above-described example of processing, as a result of verifying and checking attestation data, it is judged whether the service providing device 120 conforms to the demanded security policy.

In the following example, if it is determined that it is not possible to use a service of the service providing device 120 because it does not conform to the security policy, the information processing apparatus 100 searches for an alternative to a certain function demanded by the security policy and replaces the function by this alternative function. Then, the information processing apparatus 100 obtains attestation data generated by using the security policy including this alternative function. If it is judged based on this security policy that a service of the service providing device 120 can be used, the information processing apparatus 100 proposes the security policy including the alternative function to the management device 180.

A block diagram for explaining processing concerning this alternative function is shown in FIG. 14.

FIG. 14 is a schematic diagram of specific modules forming an example of the configuration of the exemplary embodiment. Elements similar to those in FIG. 6 are designated by like reference numerals, and an explanation thereof will be omitted.

The management device 180 includes a network communication block 650 and a security policy retaining block 655.

The network communication block 650 is connected to the security policy retaining block 655, and is also connected to a network communication block 640 of the information processing apparatus 100 via the firewall device 140 and the communication network 190.

The security policy retaining block 655 is connected to the network communication block 650.

The information processing apparatus 100 includes a local communication block 630, a driver 1435, and the network communication block 640.

The local communication block 630 is connected to the driver 1435, and is also connected to a local communication block 615 of the service providing device 120 via the communication network 135.

The driver 1435 includes a signature verifying logic 1440, a collation result checking logic 1442, an alternative-function searching logic 1444, and an alternative-security-policy creating logic 1460. The driver 1435 is connected to the local communication block 630 and the network communication block 640.

The signature verifying logic 1440 has a function equivalent to that of the signature verifying block 660 of the management device 180 shown in FIG. 6.

The collation result checking logic 1442 has a function equivalent to that of the collation result checking block 665 of the management device 180 shown in FIG. 6.

The alternative-function searching logic 1444 includes an alternative-function table 1446. When it is found that it is not possible to use a service requested by a user because the service providing device 120 does not conform to the security policy, the alternative-function searching logic 1444 searches the alternative-function table 1446 for an alternative to a certain function demanded by the security policy.

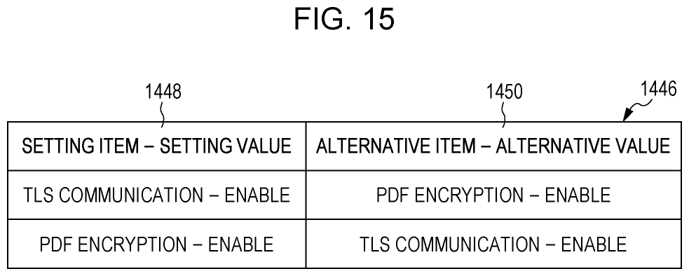

The alternative-function table 1446 stores a setting item and an item alternative to this setting item in association with each other. FIG. 15 illustrates an example of the data structure of the alternative-function table 1446. The alternative-function table 1446 has a setting-item/setting-value field 1448 and an alternative-item/alternative-value field 1450. The setting-item/setting-value field 1448 stores a combination of a setting item and a setting value. The alternative-item/alternative-value field 1450 stores a combination of an alternative item and an alternative value, which serves as an alternative to the combination of the setting item and the setting value.

The first row of the alternative-function table 1446 shows that the alternative to “TLS communication—enable” in the setting-item/setting-value field 1448 is “PDF encryption—enable” in the alternative-item/alternative-value field 1450. That is, if “TLS communication is enable” is demanded by the security policy, it can be replaced by “PDF encryption is enable”. The second row of the alternative-function table 1446 shows that the alternative to “PDF encryption—enable” in the setting-item/setting-value field 1448 is “TLS communication—enable” in the alternative-item/alternative-value field 1450. That is, if “PDF encryption is enable” is demanded by the security policy, it can be replaced by “TLS communication is enable”.

The alternative-security-policy creating logic 1460 creates a new security policy by using the alternative setting item and the alternative setting value searched for by the alternative-function searching logic 1444. More specifically, the alternative-security-policy creating logic 1460 replaces the setting item and the setting value that do not match the function of the service providing device 120 by the alternative setting item and the alternative setting value. The information processing apparatus 100 then sends the new security policy to the service providing device 120 and receives attestation data 678 from the service providing device 120.

The network communication block 640 is connected to the driver 1435, and is also connected to the network communication block 650 of the management device 180 via the communication network 190 and the firewall device 140.

The service providing device 120 includes a signature key retaining block 605, a setting retaining block 610, the local communication block 615, and an attestation block 620.

The signature key retaining block 605 is connected to the attestation block 620. The signature key retaining block 605 supplies a signature key 672 to the attestation block 620.

The setting retaining block 610 is connected to the attestation block 620. The setting retaining block 610 supplies setting values 674 to the attestation block 620.

The local communication block 615 is connected to the attestation block 620, and is also connected to the local communication block 630 of the information processing apparatus 100 via the communication network 135. The local communication block 615 supplies a security policy 676 to the attestation block 620 and receives the attestation data 678 from the attestation block 620.

The attestation block 620 includes a mask logic 622, a collation logic 624, and a signature logic 626. The attestation block 620 is connected to the signature key retaining block 605, the setting retaining block 610, and the local communication block 615. The attestation block 620 receives the signature key 672 from the signature key retaining block 605, the setting values 674 from the setting retaining block 610, and the security policy 676 from the local communication block 615, and then supplies the attestation data 678 to the local communication block 615.

The mask logic 622 is connected to the collation logic 624.

The collation logic 624 is connected to the mask logic 622 and the signature logic 626.

The signature logic 626 is connected to the collation logic 624.

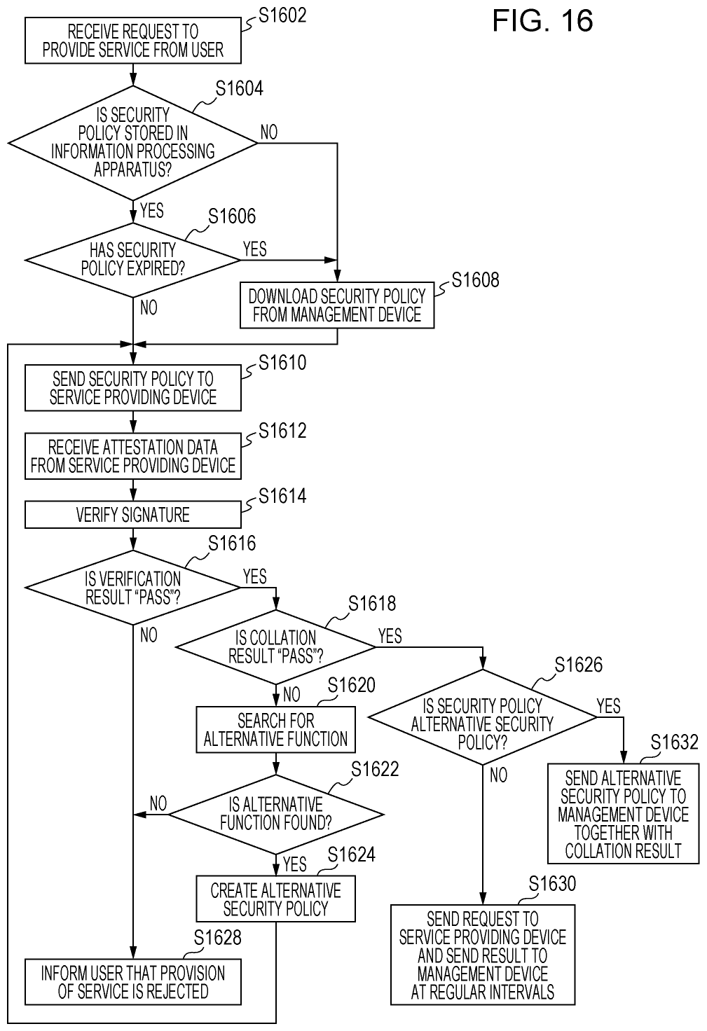

An example of processing executed by the information processing apparatus 100 shown in FIG. 14 will be described below with reference to FIG. 16. FIG. 16 is a flowchart illustrating an example of processing executed in the exemplary embodiment from the viewpoint of the information processing apparatus 100. The processing shown in FIG. 16 is equivalent to that shown in FIG. 12 to which steps S1620 through S1626, S1630, and S1632 are added.

In step S1602, the information processing apparatus 100 receives a request to provide a service from a user.

In step S1604, the information processing apparatus 100 judges whether the security policy is stored in the information processing apparatus 100. If the security policy is stored, the information processing apparatus 100 proceeds to step S1606. If the security policy is not stored, the information processing apparatus 100 proceeds to step S1608.

In step S1606, the information processing apparatus 100 judges whether the security policy has expired. If the security policy has expired, the information processing apparatus 100 proceeds to step S1608. If the security policy has not expired, the information processing apparatus 100 proceeds to step S1610.

In step S1608, the information processing apparatus 100 downloads the security policy from the management device 180.

In step S1610, the information processing apparatus 100 sends the security policy to the service providing device 120.

In step S1612, the information processing apparatus 100 receives attestation data from the service providing device 120.

In step S1614, the information processing apparatus 100 verifies a signature attached to the attestation data.

In step S1616, the information processing apparatus 100 judges whether the verification result is “PASS”. If the verification result is “PASS”, the information processing apparatus 100 proceeds to step S1618. If the verification result is not “PASS”, the information processing apparatus 100 proceeds to step S1628.

In step S1618, the information processing apparatus 100 judges whether the collation result is “PASS”. If the collation result is “PASS”, the information processing apparatus 100 proceeds to step S1626. If the collation result is not “PASS”, the information processing apparatus 100 proceeds to step S1620.

In step S1620, the information processing apparatus 100 searches for an alternative function.

In step S1622, it is judged whether an alternative function has been found. If an alternative function is found, the information processing apparatus 100 proceeds to step S1624. If an alternative function is not found, the information processing apparatus 100 proceeds to step S1628.

In step S1624, the information processing apparatus 100 creates an alternative security policy and returns to step S1610.

In step S1626, it is judged whether the security policy is an alternative security policy. If the security policy is an alternative security policy, the information processing apparatus 100 proceeds to step S1632. If the security policy is not an alternative security policy, the information processing apparatus 100 proceeds to step S1630.

In step S1628, the information processing apparatus 100 informs the user that the provision of a service is rejected.

In step S1630, the information processing apparatus 100 sends the service request to the service providing device 120, and sends the result to the management device 180 at regular intervals. The result sent to the management device 180 may include the collation result of the security policy and the processing result of the service providing device 120.

In step S1632, the information processing apparatus 100 sends the alternative security policy to the management device 180, together with the collation result obtained by using the alternative security policy.

The administrator of the management device 180 may examine the content of the alternative security policy received as a result of step S1632, and register it as a new security policy of the organization if nothing is wrong with the content. Thereafter, a user is allowed to use a service provided by the service providing device 120.

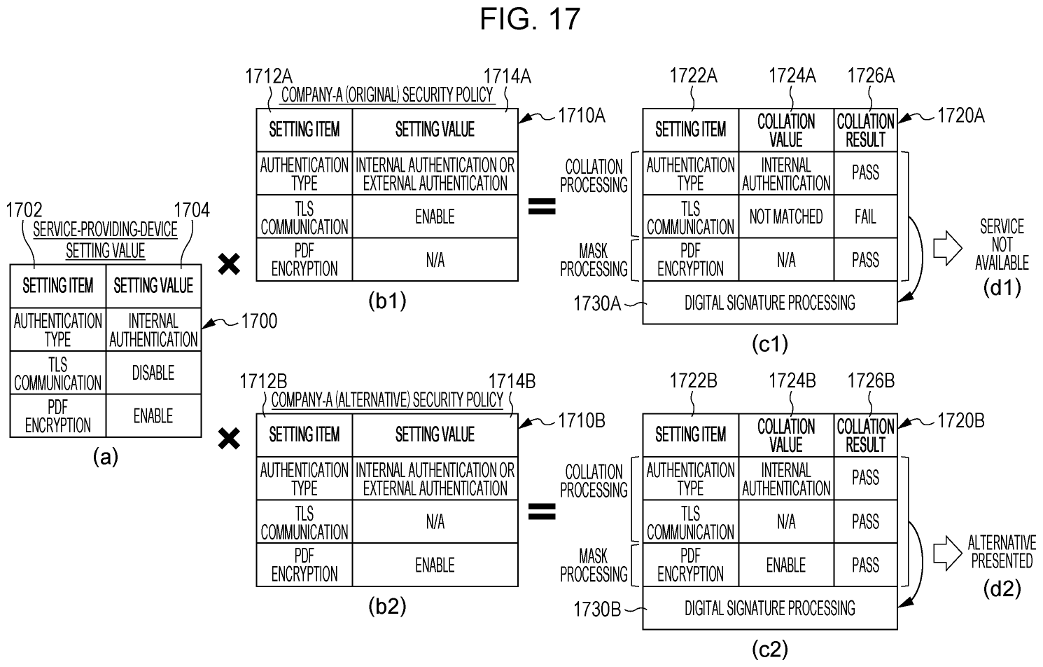

FIG. 17 illustrates an example of processing executed in the exemplary embodiment based on the flowchart of FIG. 16.

An example of processing executed with the security policy within the management device 180 will first be discussed below through illustration of the procedure of (a), (b1), (c1), and (d1) of FIG. 17.

In FIG. 17, (a) shows an example of the data structure of a service-providing-device setting value table 1700. The service-providing-device setting value table 1700 indicates setting values of the service providing device 120 and is stored in the setting retaining block 610 of the service providing device 120.

The service-providing-device setting value table 1700 has a setting item field 1702 and a setting value field 1704. The setting item field 1702 stores setting items. The setting value field 1704 stores setting values of the service providing device 120 associated with the individual setting items.

For example, in the service-providing-device setting value table 1700, “internal authentication” is set as the authentication type, “disable” is set as TLS communication, and “enable” is set as PDF encryption.

In FIG. 17, (b1) shows an example of the data structure of a company-A (original) security policy table 1710A, that is, the original security policy of company A managed by the management device 180.

The company-A (original) security policy table 1710A has a setting item field 1712A and a setting value field 1714A. The setting item field 1712A stores setting items. The setting value field 1714A stores setting values associated with the individual setting items.

For example, in the company-A (original) security policy table 1710A, “internal authentication or external authentication” is set as the authentication type, “enable” is set as TLS communication, and “N/A” is set as PDF encryption.

In FIG. 17, (c1) shows an example of the data structure of a collation result table 1720A.

The collation result table 1720A has a setting item field 1722A, a collation value field 1724A, and a collation result field 1726A. The setting item field 1722A stores setting items. The collation value field 1724A stores the collation values associated with the individual setting items. The collation result field 1726A stores the collation results associated with the individual setting items.

For example, the first row of the collation result table 1720A shows that, regarding the authentication type in the setting item field 1722A, the collation value field 1724A indicates “internal authentication” and the collation result field 1726A indicates “PASS”. The second row of the collation result table 1720A shows that, regarding TLS communication in the setting item field 1722A, the collation value field 1724A indicates “not matched” and the collation result field 1726A indicates “FAIL”. The third row of the collation result table 1720A shows that, regarding PDF encryption in the setting item field 1722A, the collation value field 1724A indicates “N/A” and the collation result field 1726A indicates “PASS”.

Then, digital signature processing 1730A is executed on the collation result table 1720A.

In this example, it is determined that it is not possible to use a service of the service providing device 120 (“service not available”), as shown in (d1). Then, a company-A (alternative) security policy table 1710B shown in (b2) of FIG. 17 is generated from the company-A (original) security policy table 1710A in (b1) of FIG. 17.

An example of processing executed with an alternative security policy will now be discussed below through illustration of the procedure of (a), (b2), (c2), and (d2) of FIG. 17.

In FIG. 17, (b2) shows an example of the data structure of the company-A (alternative) security policy table 1710B.

The company-A (alternative) security policy table 1710B has a setting item field 1712B and a setting value field 1714B. The setting item field 1712B stores setting items. The setting value field 1714B stores setting values associated with the individual setting items.

For example, in the company-A (alternative) security policy table 1710B, “internal authentication or external authentication” is set as the authentication type, “N/A” is set as TLS communication, and “enable” is set as PDF encryption. That is, instead of “TLS communication—enable” in the company-A (original) security policy table 1710A, which has caused the collation result to be “FAIL”, “PDF encryption—N/A” is changed to “PDF encryption—enable”. “TLS communication—enable” is changed to “TLS communication—N/A”.

In FIG. 17, (c2) shows an example of the data structure of a collation result table 1720B.

The collation result table 1720B has a setting item field 1722B, a collation value field 1724B, and a collation result field 1726B. The setting item field 1722B stores setting items. The collation value field 1724B stores the collation values associated with the individual setting items. The collation result field 1726B stores the collation results associated with the individual setting items.

For example, the first row of the collation result table 1720B shows that, regarding the authentication type in the setting item field 1722B, the collation value field 1724B indicates “internal authentication” and the collation result field 1726B indicates “PASS”. The second row of the collation result table 1720B shows that, regarding TLS communication in the setting item field 1722B, the collation value field 1724B indicates “N/A” and the collation result field 1726B indicates “PASS”. The third row of the collation result table 1720B shows that, regarding PDF encryption in the setting item field 1722B, the collation value field 1724A indicates “enable” and the collation result field 1726B indicates “PASS”.

Then, digital signature processing 1730B is executed on the collation result table 1720B.

In this example, it is determined that it is possible to use a service (“service available”), and the alternative security policy is proposed to the management device 180 (“alternative presented”), as shown in (d2) of FIG. 17.

That is, in this example, it is not possible to use a service of the service providing device 120 based on the original security policy (company-A (original) security policy table 1710A) that demands “TLS communication is enable”. Hence, by using the alternative-function table 1446, an alternative security policy (company-A (alternative) security policy table 1710B) in which “TLS communication is enable” is replaced by “PDF encryption is enable” is created. It is judged based on this alternative security policy that it is possible to use a service of the service providing device 120. The alternative security policy is thus sent to the management device 180.

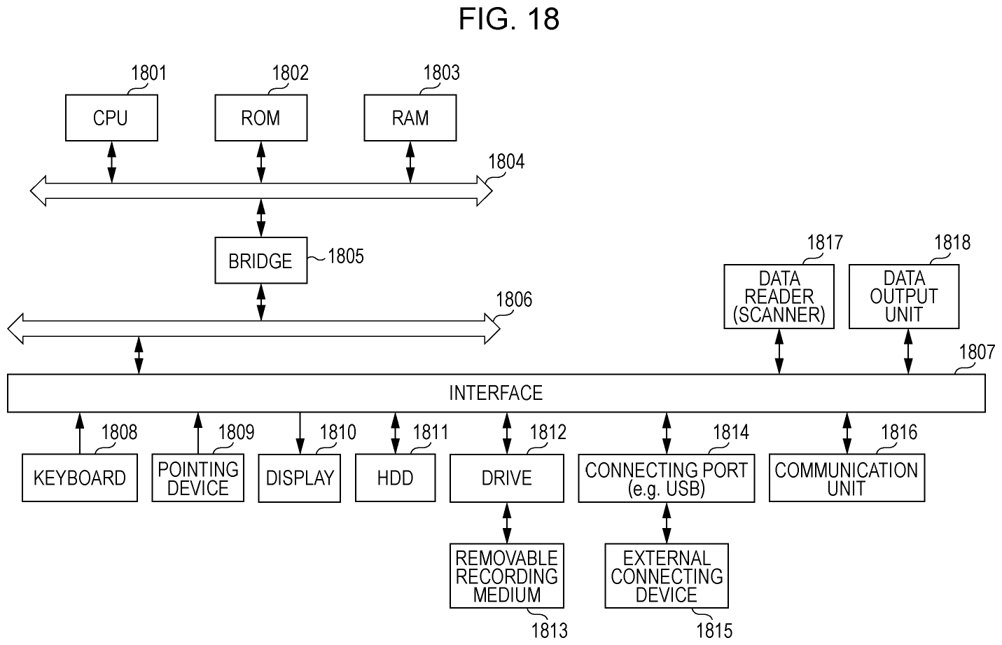

An example of the hardware configuration of the information processing apparatus 100, the service providing device 120, and the management device 180 of the exemplary embodiment will be described below with reference to FIG. 18. The hardware configuration shown in FIG. 18 is implemented as a personal computer (PC), for example, and includes a data reader 1817, such as a scanner, and a data output unit 1818, such as a printer.

A CPU 1801 is a control unit that executes processing in accordance with a computer program describing an execution sequence of the modules of the above-described exemplary embodiment, such as the communication module 210, the management-device communication module 212, the service-providing-device communication module 214, the control module 220, the decision module 222, the collation module 224, the display control module 228, the communication module 310, the information-processing-apparatus communication module 312, the control module 320, the collation module 322, the state detection module 324, the service providing module 340, the image processing module 440, the local communication block 615, the attestation block 620, the mask logic 622, the collation logic 624, the signature logic 626, the local communication block 630, the driver 635, the network communication block 640, the network communication block 650, the signature verifying block 660, the collation result checking block 665, the driver 1435, the signature verifying logic 1440, the collation result checking logic 1442, the alternative-function searching logic 1444, and the alternative-security-policy creating logic 1460.

A read only memory (ROM) 1802 stores programs and operation parameters used by the CPU 1801. A RAM 1803 stores programs used during the execution of the CPU 1801 and parameters which change appropriately during the execution of the programs. The CPU 1801, the ROM 1802, and the RAM 1803 are connected to one another via a host bus 1804, which is constituted by, for example, a CPU bus.

The host bus 1804 is connected to an external bus 1806, such as a peripheral component interconnect/interface (PCI) bus, via a bridge 1805.

A keyboard 1808 and a pointing device 1809, such as a mouse, are devices operated by an operator. A display 1810, which is an example of the display module 230, is a liquid crystal display, an organic EL display, or a cathode ray tube (CRT), for example, and displays various items of information as text or image information. Alternatively, a touchscreen having both the functions of the pointing device 1809 and the display 1810 may be provided. In this case, to implement the function of the keyboard, a keyboard drawn on a screen (touchscreen, for example) by using software, that is, a so-called software keyboard or screen keyboard, may be used instead of the keyboard 1808, which is a physical keyboard.

A hard disk drive (HDD) 1811 has a built-in hard disk (may alternatively be a flash memory, for example) and drives the hard disk so as to record or play back information or a program executed by the CPU 1801. The HDD 1811 implements functions of the security policy storage module 226, the signature key retaining block 605, the setting retaining block 610, and the security policy retaining block 655. Various other items of data and various other computer programs are also stored in the HDD 1811.

A drive 1812 reads data or a program recorded in a removable recording medium 1813, such as a magnetic disk, an optical disc, a magneto-optical disk, or a semiconductor memory, and supplies the read data or program to the RAM 1803 via an interface 1807, the external bus 1806, the bridge 1805, and the host bus 1804. The removable recording medium 1813 may also be used as a data recording region.

A connecting port 1814 is a port for connecting the PC to an external connecting device 1815, and has a connecting portion, such as a universal serial bus (USB) port or an IEEE1394 port. The connecting port 1814 is connected to, for example, the CPU 1801, via the interface 1807, the external bus 1806, the bridge 1805, and the host bus 1804. A communication unit 1816 is connected to a communication line and executes data communication processing with an external source. The data reader 1817 is, for example, a scanner, and executes processing for reading a document. The data output unit 1818 is, for example, a printer, and executes processing for outputting document data.

In the above-described exemplary embodiment, concerning elements implemented by a software computer program, such a computer program is read into a system having the hardware configuration shown in FIG. 18, and the above-described exemplary embodiment is implemented by a combination of software and hardware resources.

The hardware configuration of the information processing apparatus 100, for example, shown in FIG. 18 is only an example, and the exemplary embodiment may be configured in any manner in which the modules described in the exemplary embodiment are executable. For example, as a processor, a graphics processing unit (GPU) or a general-purpose computing on graphics processing unit (GPGPU) may be used. Some modules may be configured as dedicated hardware (for example, an application specific integrated circuit (ASIC) or a field-programmable gate array (FPGA)), or some modules may be installed in an external system and be connected to the PC via a communication line. A system, such as that shown in FIG. 18, may be connected to a system, such as that shown in FIG. 18, via a communication line, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, and a multifunction device.

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. The program may be recorded in any form, for example, it may be compressed or encrypted, as long as it can be reconstructed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an obtainer that obtains an information protection policy from a management device, the management device being unable to communicate with a service providing device;
a first sender that sends the information protection policy to the service providing device;
a receiver that receives from the service providing device a collation result indicating whether or not the service providing device conforms to the information protection policy;
a second sender that sends the collation result to the management device; and
a decider that decides that it is possible to use the service providing device if information indicating that the service providing device conforms to the information protection policy is received from the management device.

2. The information processing apparatus according to claim 1, further comprising:
a storage that stores the information protection policy,
wherein, when obtaining the information protection policy from a second time onwards, the information protection policy stored in the storage is obtained.

3. The information processing apparatus according to claim 2, wherein:
an expiration date is set for the information protection policy; and
if it is found based on the expiration date that the information protection policy stored in the storage has expired, the information protection policy is obtained from the management device.

4. The information processing apparatus according to claim 1, wherein:
the information protection policy is set for each service; and
if it is found that a service of the service providing device requested from a user conforms to the information protection policy for the service, the decider decides that it is possible to use the service.

5. The information processing apparatus according to claim 4, wherein, if it is determined based on the collation result that the service does not conform to the information protection policy, an information protection policy for an alternative service, which is an alternative to the service, is sent to the service providing device.

6. The information processing apparatus according to claim 5, wherein, if the information protection policy for the alternative service is sent to the service providing device, the information protection policy for the alternative service is sent to the management device, together with a collation result indicating whether or not the alternative service conforms to the information protection policy.

7. The information processing apparatus according to claim 1, wherein, if the collation result indicates that the service providing device dose not conform to the information protection policy, an item of the information protection policy that does not conform to the information protection policy is replaced by an alternative item of the information protection policy, and a replaced information protection policy including the alternative item is sent to the service providing device.

8. The information processing apparatus according to claim 7, wherein, if the replaced information protection policy is sent to the service providing device, the replaced information protection policy is sent to the management device, together with a collation result indicating whether or not the service providing device conforms to the replaced information protection policy.

9. A non-transitory computer readable medium storing a program causing a computer to execute a process, the process comprising:
obtaining an information protection policy from a management device, the management device being unable to communicate with a service providing device;
sending the information protection policy to the service providing device;
receiving from the service providing device a collation result indicating whether or not the service providing device conforms to the information protection policy;
sending the collation result to the management device; and
deciding that it is possible to use the service providing device if information indicating that the service providing device conforms to the information protection policy is received from the management device.

10. An information processing apparatus comprising:
obtaining means for obtaining an information protection policy from a management device, the management device being unable to communicate with a service providing device;
first sending means for sending the information protection policy to the service providing device;
receiving means for receiving from the service providing device a collation result indicating whether or not the service providing device conforms to the information protection policy;
second sending means for sending the collation result to the management device; and
deciding means for deciding that it is possible to use the service providing device if information indicating that the service providing device conforms to the information protection policy is received from the management device.
